(19) United States
(12) Patent Application Publication
(10) Pub. No.: US 2004/0049425 A1
(43) Pub. Date: Mar. 11, 2004

(54) Generic loyalty tag

(75) Inventors: Anton Bakker, Norfolk, VA (US); Marc L. Allen, Chesapeake, VA (US)

Correspondence Address: NIXON PEABODY, LLP, 401 9TH STREET, NW, SUITE 900, WASINGTON, DC, 20004-2128, US

(73) Assignee: Outsite Networks, Inc., Norfolk, VA

(21) Appl. No.: 10/648,443

(22) Filed: Aug. 27, 2003

Related U.S. Application Data
(60) Provisional application No. 60/406,048, filed on Aug. 27, 2002.
(60) Provisional application No. 60/406,050, filed on Aug. 27, 2002.

(51) Int. Cl. G06F 17/60

(52) U.S. Cl. 705/14; 705/7; 235/375

(57) ABSTRACT

Using a combination of a device identifier and a reader identifier, a loyalty system is able to determine one or more loyalty applications a user is subscribed to. Additionally, by using a formulary based reward system, multiple tiers of rewards can be issued based on different categories of product or service purchased.

### RELATED APPLICATION DATA

This application claims the benefit of and priority under 35 U.S.C. §119(e) to U.S. Patent Application Serial No. 60/406,050, filed Aug. 27, 2002, entitled “Generic Loyalty Tag,” and No. 60/406,048, filed Aug. 27, 2002, entitled “Gasoline Convenience Store Retail Loyalty Point System,” both of which are incorporated herein by reference in their entirety.

### BACKGROUND OF THE INVENTION

1. Field of the Invention

The systems and methods of this invention generally relate to loyalty systems. In particular, the systems and methods of this invention at least relate to a generic loyalty tag and a loyalty point determination methodology.

2. Description of Related Art

Loyalty systems reward a customer for frequent use of services, frequent purchasing of goods, or the like. For example, frequent flyer miles are a prime example of how airlines reward passengers for traveling on their particular airline. The reward, based on the number of “miles” accumulated, can vary from discounts on future airline tickets, to seat upgrades, to free tickets, or the like.

Loyalty systems are becoming more popular as a retail mechanism for obtaining, retaining and rewarding customers. Before installing a loyalty system, a retailer determines if the benefits out way the costs. Loyalty systems have existed in may forms, from simple punch card applications to large-scale electronic systems designed to interface with, for example, grocery store systems.

Typically, a customer registers with a loyalty system and in turn receives a loyalty tag, i.e., identification device, associated with that particular system. Thus, to accumulate loyalty rewards, in conjunction with each purchase of a good or service, the customer uses their loyalty tag to identify themselves to the system thereby allowing the accumulation of points, rewards, or the like.

### SUMMARY OF THE INVENTION

However, as loyalty programs are becoming increasingly more popular for frequent flyer programs, retail locations, gas stations, grocery stores, and the like, loyalty program members are increasingly found carrying multiple loyalty membership identification devices. For example, a loyalty program member may have a specific loyalty tag for a chain of gas stations, and another loyalty tag for a grocery store, and one or more loyalty tags associated with the airlines they most frequently fly on. Carrying multiple identification devices present multiple problems ranging from having multiple loyalty tags for the end user, limited compatibility between loyalty programs, cross marketing, and the like.

Likewise, loyalty systems traditionally reward customers for their loyalty based on purchases. Typically the loyalty system is point-based and linked to the total number of dollars spent. For example, in a convenience store environment, the purchases comprise fuel purchases and non-fuel purchases. A loyalty systems that rewards fuel sales and non-fuel item sales in the same way based on the dollars spent presents a problem since, for example, the margin on sales of fuel and non-fuel items vary vastly. For example, a typical non-fuel sale may have 30% gross margin whereas a typical fuel sale may have a 9% gross margin. Thus, it would be advantageous to provide a loyalty mechanism for a retailer that rewards fuel purchases differently from non-fuel purchases and/or that may combine the fuel reward points with the non-fuel reward point for a single reward system. This basic concept can be expanded to include differentiate types of products or services from other products or services such that, for example, different loyalty rewards can be based on one or more categories or types of related goods or services.

Exemplary aspects of the invention relate to loyalty systems.

Exemplary aspects of the invention also relate to a loyalty tag that can be used a plurality of different locations.

Exemplary aspects of the invention further relate to a loyalty tag that can be used at a plurality of non-related locations.

Exemplary aspects of the invention additionally relate to a loyalty point system.

Exemplary aspects of the invention further relate to a loyalty point system that issues different rewards based on specific categories of goods or services purchased.

Exemplary aspects of the invention further relate to a loyalty point system that issues different rewards based on different categories of goods or services purchased.

Exemplary aspects of the invention further relate to a loyalty reward system wherein different categories of rewards can be issued for a single purchase.

Exemplary aspects of the invention additionally relate to a loyalty system that can provide varied rewards based on whether the purchases are for fuel or non-fuel transactions.

These and other features and advantages of this invention as described in, or are apparent from, the following detailed description of the embodiments.

### BRIEF DESCRIPTION OF THE DRAWINGS

The embodiments of the invention will be described in detail, with reference to the following figures, wherein:

FIG. 1 is functional block diagram illustrating an exemplary loyalty system according to this invention;

FIG. 2 is a detailed functional block diagram of a loyalty module according to this invention; and

FIG. 3 is a flowchart outlining an exemplary method for managing loyalty tags and rewards according to this invention.

### DETAILED DESCRIPTION OF THE INVENTION

The exemplary systems of this invention will be described in relation to a loyalty system. However, to avoid unnecessarily obscuring the present invention, the following description omits well-known structures and devices that may be shown in block diagram form or otherwise summarized. For the purposes of explanation, numerous specific details are set forth in order to provide a thorough understanding of the present invention. It should be appreciated however that the present invention may be practiced in a variety of ways beyond the specific details set forth herein.

For example, the systems and methods of this invention can be scaled to any level and are capable of working in conjunction with various types of loyalty systems, customers and already existing systems. Furthermore, while the exemplary embodiments illustrated herein show the various components of the loyalty system collocated, it is to be appreciated that various components of this system can be located at distant portions of a distributed network, such as a WAN, and or the internet, or within a dedicated loyalty system. Thus, it should be appreciated that the components of the loyalty system can be combined into one or more devices or collocated on a particular node of a distributed network such as a communications network. It should be appreciated from the following description, and for reasons of computational efficiency, that the components of the loyalty system can be arranged at any location within a distributed network without affecting the operation of the system.

Additionally, it should be appreciated that the various links connecting the elements can be wired or wireless links, or any combination thereof, or any other know or later developed element(s) that is capable of supplying and/or communicating data to and from the connected elements. Additionally, the term module has as used herein can refer to any known or later developed hardware, software, or combination of hardware and software that is capable of performing the functionality associated with that element. Likewise, for example, to facilitate scaling of the system, one or more components of the loyalty system can be mirrored and supplemented with, for example, load sharing functionality as necessary. Similarly, each of the components illustrated in the loyalty module can be distributed, replicated, and/or mirrored at one or more loyalty modules and loyalty servers within the loyalty system.

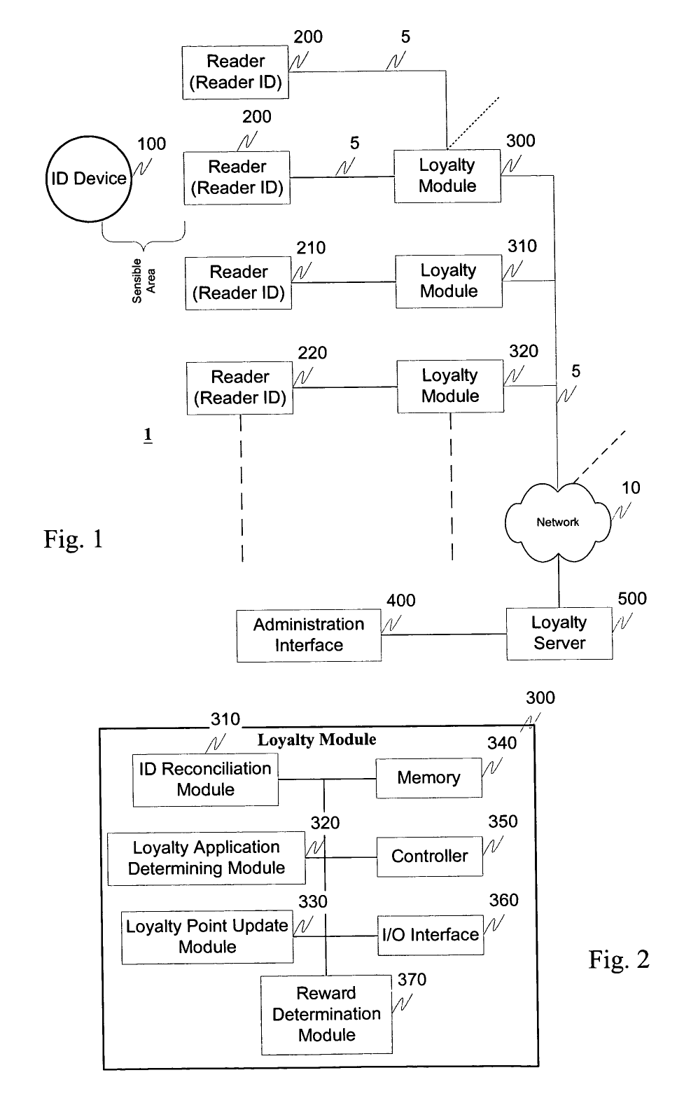

FIG. 1 illustrates an exemplary loyalty system 1. The loyalty system 1 comprises one or more readers 200, 210, 220, each having an associated reader ID, with more than one reader being capable of being attached to each of one or more loyalty modules 300, 310, 320, one or more ID devices 100, each having a device identifier, a loyalty server 500 and an administration interface 400, with the various components being interconnected by one or more links 5 and network(s) 10. In general, and in accordance with an exemplary embodiment, each reader has associated reader identification (reader ID) that identifies the reader. Thus, upon, for example, a user introducing the ID device 100 into the sensible area of a reader, the combination of the device identifier on the ID device 100 and the reader ID on the reader 200 are used to determine which loyalty application(s) the ID device 100 is being used for. For example, using the combination of reader ID and device identifier on the ID device 100, one or more particular loyalty applications can be selected or, for example, as an alternative, a particular loyalty application excluded.

For example, the ID device and readers can be equipped with electrical, electromechanical, magnetic, inductive, capacitive and/or optical communication systems, the reader can be a credit card reader and the ID device a credit card, the reader a radio frequency identification device (RFID) and the ID device an RFID tag, or in general, any device or combination of devices that are capable of communicating and exchanging information, such as identifiers, between the identification device and the reader. In addition to the identifier information, the ID device 100 can also store and/or receive profile information, loyalty information, reward information, and the like.

Thus, in operation, the loyalty server 500 is configured and populated with, for example, via the administration interface 400, the various readers, and associated reader IDs, and device identifiers that are in the system. Since each ID device 100 has a specific device identifier, and each reader has an associated reader ID, for example, through the use of a table, the loyalty system 1 can determine one or more appropriate loyalty applications based on this combination of IDs.

For example, the various combination of IDs can be stored in a table or similar database that allows the loyalty system 1 to determine the appropriate loyalty application based on which reader the ID device 100 is presented to. Specifically, upon presentment of the ID device 100 to a reader, such as reader 200, the reader 200 communicates, via link 5, with the loyalty module 300. The loyalty module 300 having all or a portion of the reconciliation table stored thereon, is then able to determine the appropriate loyalty application(s) for use with this ID device 100. Alternatively, the loyalty module 300, upon receiving the combination of the device identifier from the ID device 100 and the reader ID from the reader 200, can forward this information, via link 5 and network 10, to the loyalty server 500. Additionally, the ID device can be auto-registered upon presentment to the system and one or more of a loyalty application automatically determined or the user queried for which loyalty program they would like to become a member of. The loyalty server 500 can then determine the appropriate loyalty application(s) and respond to the loyalty module 300 with the appropriate instructions for which loyalty application(s) is appropriate and, for example, how to determine loyalty rewards. Upon selection of the appropriate loyalty application, the loyalty module 300 can update the loyalty rewards, if any, for the user associated with ID device 100. For example, the loyalty module 300 in cooperation with the reader 200, can transfer information to a memory (not shown) located on the ID device 100 that is capable of storing the rewards information. Alternatively, one or more of the loyalty module 300 and loyalty server 500 can maintain a record of the rewards earned in conjunction with the current transaction.

FIG. 2 illustrates in greater detail an exemplary loyalty module 300. However, it should be appreciated, that while the components within the loyalty module 300 are shown collocated in the loyalty module, one or more of these components could also be distributed within the loyalty system 1, such as in the loyalty server 500. In particular, the loyalty module 300 comprises an ID reconciliation module 310, a loyalty application determining module 320, a loyalty point update module 330, a memory 340, a controller 350, an I/O interface 360 and a reward determination module 370.

In operation, the loyalty module 300 receives, from the associated reader and once an ID device is introduced into the sensible area of the reader, the reader ID and the device identifier associated with the ID device 100.

Typically the ID reconciliation module just forwards the device identifier and the reader ID to the loyalty application determining module 320. However, the ID reconciliation module 310 is not only capable of detecting and forwarding the device identifier associated with the ID device 100 and the reader ID to the loyalty application determining module 320, but is also capable of analyzing the received device identifier and determining if the device identifier should be passed directly to the loyalty application determining module 320 in conjunction with the reader ID, or, if the device identifier needs to be interpreted and, for example, a derivative identifier forwarded to the loyalty application determining module. For example, the ID reconciliation module 310 can analyze the device identifier and, since the loyalty module 300 is aware of the environment of the reader 200, recognize that a derivative or portion of the device identifier should be forwarded to the application determining module 320. For example, if the ID device is a credit card, or in general any device having an associated identifier, the ID reconciliation module could perform a look-up of the associated identifier and determine an appropriate derivative identifier that can be used in conjunction with the reader ID to determine the one or more appropriate loyalty applications. Thus, the system is not limited to use of specific identifiers associated with, for example, loyalty tags per se, but can be used in conjunction with any device having an associated device identifier.

Likewise, the ID reconciliation module 310 can perform a check to determine if the read device identifier is associated with a particular type of user, such as a subscribed user. For example, if a subscribed user is a member of a national gas station loyalty program, the one or more appropriate loyalty applications could be a loyalty application associated with the national chain of gas stations, a loyalty application associated with a particular product and/or a loyalty application associated with the particular store visited.

With the device identifier and reader ID, the loyalty application determining module 320 is able to determine the one or more appropriate loyalty applications for the transaction. Specifically, for each loyalty application associated with the current transaction, the loyalty application determining module 320 cooperates with the loyalty point update module 330 to determine if different rewards should be allocated for different types of purchases. If different rewards are to be allocated for different types of purchases, the loyalty point update module 330 cooperates with the reward determination module 370 to determine if the reward is appropriate for each category of purchase. However, if different rewards are not available for different classes or categories of purchases, the reward determination module 370 determines the award and the loyalty point update module 330 updates one or more of an earned reward memory (not shown) on the ID device 100, or an earned reward storage (not shown) in the loyalty system 1.

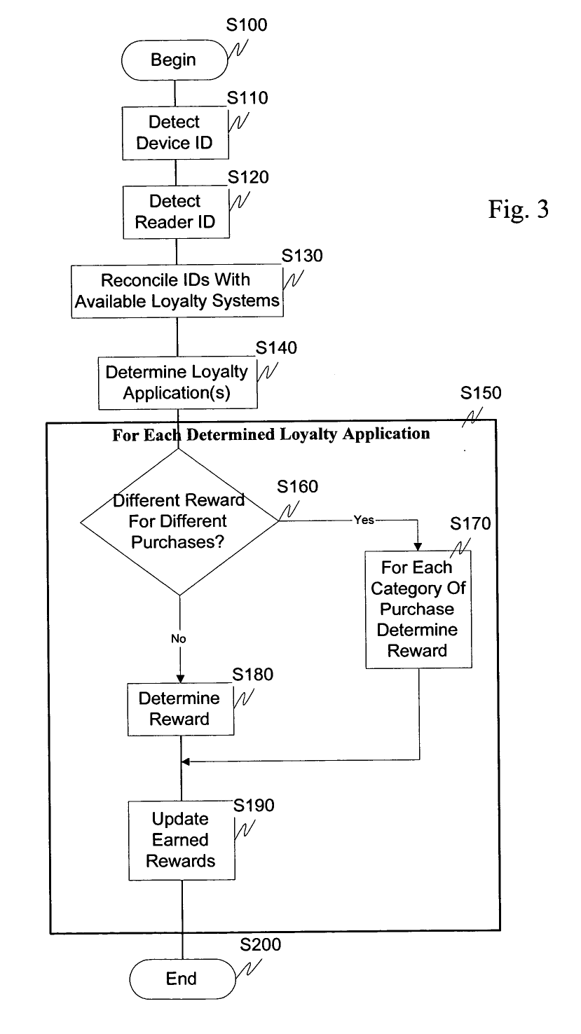

FIG. 3 outlines an exemplary method of the operation of a loyalty system. In particular, control begins in step S100 and continues to step S110. In step S110, a device ID is detected. Next, in step S120, a reader ID is detected. Then, in step S130, the device identifier and reader ID are reconciled with available loyalty systems to determine if, for example, a derivative device identifier should be used and which loyalty system should be used. Control then continues to step S140.

In step S140, based on the detected device identifier and reader ID, one or more loyalty applications are determined. Then, in step S150, for each determined loyalty application, a determination is made whether for the current loyalty application a different reward is awarded for different categories of purchases. If different awards are rewarded for different types, categories or classes of purchase, control continues to step S170. Otherwise, control jumps to step S180.

In step S170 for each type, category or class of purchase, a reward can be determined. Control then continues to step 190.

Alternatively, in step S180, a reward for the current purchase is determined.

In step S190, the earned rewards are updated, for example as discussed above, by storing the updated reward information on one or more of the ID device or in the loyalty system network. Control then continues to step S200 where the control sequence ends.

Specifically, and as discussed above, loyalty systems traditionally reward customers for there loyalty based on purchases. Loyalty systems are typically point-based systems linked to dollars spent for a particular category or product. However, in many environments, several different categories or product are available for purchase. By dividing the purchase transaction information into one or more categories, the loyalty system is able to award loyalty rewards for one or more categories of sales. For example, typical loyalty mechanisms only have one type of reward system. By assigning different categories to different types or classes of products, the loyalty system is able to provide rewards for one or more categories of goods, or, alternatively, may combine one or more categories of goods for use in another type of loyalty reward program. As an example the following exemplary formulary based approaches can be used to determine rewards. However, in general, it should be appreciated that any reward determination methodology can be used with equal success with the systems and method of this invention.

Fuel Reward Point Determination

| | |
|---|---|
| X1 gallons = Y1 fuel points | Fuel reward factor = Y1/X1 or |
| X2 dollars of fuel = Y2 points | Fuel rewards factor = Y2/X2 |

Non-Fuel Reward Point Determination

| | |
|---|---|
| X3 dollars of non-fuel = Y3 points | Non-Fuel reward factor = Y3/X3 |
| X4 dollars of category 1 item(s) = Y4 | Rewards factor = Y4/X4 |
| points | |

Point Determination

| | |
|---|---|
| A items = B reward points | Reward factor = A/B |
| N Number of Items D and E = F reward | Reward factor = (ND + NE)/F |
| points | |
| C dollars (total transaction) = C1 points | Rewards factor C1/C |

The above-described systems and methods can be implemented on a loyalty system, marketing system, advertising system, or the like, or on a separate programmed general purpose computer having loyalty capabilities. Additionally, the systems and methods of this invention can be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, stored as instructions on a recordable media, or the like. In general, any device capable of implementing a state machine that is in turn capable of implementing the flowcharts illustrated herein can be used to implement the system according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The systems and methods illustrated herein however can be readily implemented in hardware and/or software using any known or later developed systems or structures, devices and/or software by those of ordinary skill in the applicable art from the functional description provided herein and with a general basic knowledge of the computer and loyalty system arts.

Moreover, the disclosed methods may be readily implemented in software executed on programmed general purpose computer, a special purpose computer, a microprocessor, or the like. In these instances, the systems and methods of this invention can be implemented as program embedded on personal computer such as JAVA® or CGI script, as a resource residing on a server or graphics workstation, as a routine embedded in a loyalty system, or the like. The system can also be implemented by physically incorporating the system and method into a software and/or hardware system, such as the hardware and software systems of a loyalty reward system.

It is, therefore, apparent that there has been provided, in accordance with the present invention, systems and methods for a loyalty reward system. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A loyalty system comprising:
a device identification reader adapted to read a device identifier from an identification device; and
a loyalty application determining module capable of determining one or more loyalty applications based on a combination of the device identifier and an identifier associated with the device identification reader.

2. The system of claim 1, wherein the loyalty system is further capable of determining different rewards based on different categories of items purchased.

3. The system of claim 1, further comprising a reward determination module adapted to allocate loyalty rewards based on a formulary, the formulary capable of distinguishing between different types of items within a transaction.

4. The system of claim 1, further comprising an administration interface that allows updating of one or more of a reward determination formulary, transaction information, user information, member information, device identification reader information and device identifiers.

5. The system of claim 1, further comprising a loyalty point updating module that updates a user's loyalty points on one or more of a loyalty module, a loyalty host and the identification device.

6. The system of claim 1, wherein the identification device is generic and can be used with one or more of related or non-related device identification readers.

7. The system of claim 1, wherein the one or more loyalty applications are for one or more of a grocery store, a gas station, an airline, a retail store, a restaurant, a movie theater, a convenience store, a quick service restaurant and a department store.

8. A loyalty reward determination method comprising:
reading a device identifier from an identification device;
obtaining a device identification reader identifier; and
determining one or more loyalty applications based on a combination of the device identifier and the device identification reader identifier.

9. The method of claim 8, further comprising determining different rewards based on different categories of items purchased.

10. The method of claim 8, further comprising allocating loyalty rewards based on a formulary, the formulary capable of distinguishing between different types of items within a transaction.

11. The method of claim 8, further comprising updating of one or more of a reward determination formulary, transaction information, user information, member information, device identification reader information and device identifiers.

12. The method of claim 8, further comprising updating a user's loyalty points on one or more of a loyalty module, a loyalty host and the identification device.

13. The method of claim 8, wherein the identification device is generic and can be used with one or more of related or non-related device identification readers.

14. The method of claim 8, wherein the one or more loyalty applications are for one or more of a grocery store, a gas station, an airline, a retail store, a restaurant, a movie theater, a convenience store, a quick service restaurant and a department store.

15. A loyalty reward determination system comprising:
means for reading a device identifier from an identification device;
means for obtaining a device identification reader identifier; and
means for determining one or more loyalty applications based on a combination of the device identifier and the device identification reader identifier.
